(19) United States
(12) Patent Application Publication
(10) Pub. No.: US 2010/0306678 A1
(43) Pub. Date: Dec. 2, 2010

(54) USER INTERFACE CONTROLS INCLUDING CAPTURING USER MOOD

(76) Inventor: Charles J. Kulas, San Francisco, CA (US)

Correspondence Address: CHARLES J. KULAS, 651 ORIZABA AVE., SAN FRANCISCO, CA, 94132, US

(21) Appl. No.: 12/473,831

(22) Filed: May 28, 2009

(51) Int. Cl. G06F 3/00; G06F 3/048

(52) U.S. Cl. 715/760; 715/846; 715/823; 715/862; 715/700; 715/764

(57) ABSTRACT

A method for operating at least one control in a graphical user interface that provides a user to output state of mind about current contents by selecting at least one of a multiple areas associated thereof. A change in texture is observed when a pointer is over at least one of the areas of the at least one control. The change in texture of the at least one control preferably includes a grid like cross-hatching, a diagonal hatching, a color change or any other visual indicators. A click on at least one of the areas of the control simultaneously operates the control and outputs the user's state of mind corresponding to the particular area. The method can be applicable to each of a navigational control, video transport control, web browser control, hyperlink, software application and computer operating system.

### BACKGROUND

Embodiments of the invention relate generally to operating a control in a graphical user interface and more specifically to obtaining a user characteristic, such as the user's state of mind, concurrently or in association with an operation of a user control.

Advancement in web technology has enabled the spread of information over the internet via an easy-to-use format. The increase in demand for improving the service provided to a user forced service providers to determine ways of identifying a user's state of mind. Taking a survey that requires answers to a specific set of questionnaires were the initial practice employed to identify user's sentiments. Even though the outcome of such a survey appears to be less reliable, the information is of high importance for commercial users of computers in such fields as marketing, advertising, product improvement, business planning, etc. Again, the information about a user's state of mind is useful for businesses, sociologists and those from other fields to obtain statistics and characteristics about users.

Existing methods for identifying a user's state of mind often require the user to fill out a survey or answer specific questions by typing text or performing selections. This requires additional time and computer operation so a user often will not provide the state-of-mind information. Other approaches that attempt to determine a user's state of mind automatically by analyzing what a user is doing include scanning or interpreting the user's comments posted on the Internet. Calculation of the total amount of time the user spends on a web page, the number and type of mouse clicks or movements, and other actions performed by a user while using a computer can be used to try to determine the user's feelings or attitudes. However, these automated approaches to indirectly determine user state of mind are often not reliable.

### SUMMARY

Embodiments of the present invention provide a method for operating a control in a graphical user interface (GUI) concurrently or in association with receiving a user indication of the user's state of mind. For example, a GUI control may include navigation controls in a web browser (page forward, page back, open or close a window or tab, etc.); video transport control (play, pause, stop, rewind, fast forward, scrub, etc.); hyperlink on a web page; a control in a software application, computer operating system or other function provided in a processing system interface. In a particular embodiment, two or more areas are defined on a control's surface, or image area. When the user operates the control, such as a window close button, depending on whether the user clicks in a first area or in a second area in order to activate the window close function, the indication of the user's state of mind can be, respectively “approval” or “disapproval” of the window's content.

An embodiment of the invention provides selection of at least one of two areas associated with at least one of the controls to output at least one approval and disapproval of the user. In one embodiment, when a pointer is over at least one of the controls, the texture, color or other characteristic of displaying the control can change. A click on at least one upper area and a lower area of at least one of the controls can simultaneously activate the control and store an indication of the user's state of mind or other quality or characteristic of the user.

In another embodiment of the invention, at least one of the controls is configured into three sections such as an upper area, a middle area and a lower area. Two of the three areas can be used to indicate different user characteristics (e.g., “like” or “dislike,” etc.) and the third area can be used for operating the control without providing an indication.

The color or other characteristic (i.e., “texture”) of the different areas of the control can change when the pointer is over the control or when the control is otherwise selected upper area and the lower area remains unchanged even when the pointer is moved away from at least one of the controls. A click on the non-indicating middle area operates only the control. When the pointer is over at least one of the controls, a text bubble pops up and alerts the user about the state of mind corresponding to the selected area.

One embodiment provides a method for operating a control in a graphical user interface (GUI), the method comprising displaying a control in the GUI, wherein the control has a primary function; defining first and second areas in the control, wherein the first area corresponds with a first state of mind of a user and wherein the second area corresponds with a second state of mind of the user; accepting a signal from the user input device to operate the control and select one of either the first or second areas; detecting the selected area; and outputting an indication of the user's state of mind corresponding to the selected area.

A further understanding of the nature and the advantages of particular embodiments disclosed herein may be realized by reference of the remaining portions of the specification and the attached drawings.

### BRIEF DESCRIPTION OF THE DRAWINGS

FIG. 1 shows a screen image of a web browser window illustrating results from a search engine with at least one control configured into a plurality of areas;

FIG. 2 shows a blow-up view of a plurality of window control buttons in an upper right corner of the web browser window;

FIG. 3 shows a blow-up view of the window control buttons in an upper right corner of the web browser window with a pointer over a lower area of a close button;

FIG. 4 shows a close-up view of the pointer and the close button, the close button configured to at least two areas;

FIG. 5 shows a close-up view of the close button with the pointer over the lower area of the close button;

FIG. 6 shows a close-up view of the close button with the pointer over an upper area of the close button;

FIG. 7 shows a close-up view of a close button with a pointer over a lower area and a pop-up text bubble designating the user state of mind corresponding to a selected area;

FIG. 8 shows a close-up view of the close button with the pointer over a middle area thereof;

FIG. 9 shows a close-up view of the close button with the pointer over an upper area and a pop-up text bubble designating the user state of mind corresponding to a selected area;

FIG. 10 shows a screen image of a web browser window with the plurality of controls, each being configured into a plurality of areas;

FIG. 11 shows a screen image of a web browser window with video transfer controls configured into a plurality of areas; and

FIG. 12 shows an operational flowchart illustrating the steps for operating a control in a graphical user interface (GUI).

FIG. 13 illustrates a device that includes example hardware components suitable for use with particular embodiments of the invention.

FIG. 14 illustrates an arrangement of software modules suitable for implementing particular embodiments of the invention.

### DETAILED DESCRIPTION OF EMBODIMENTS

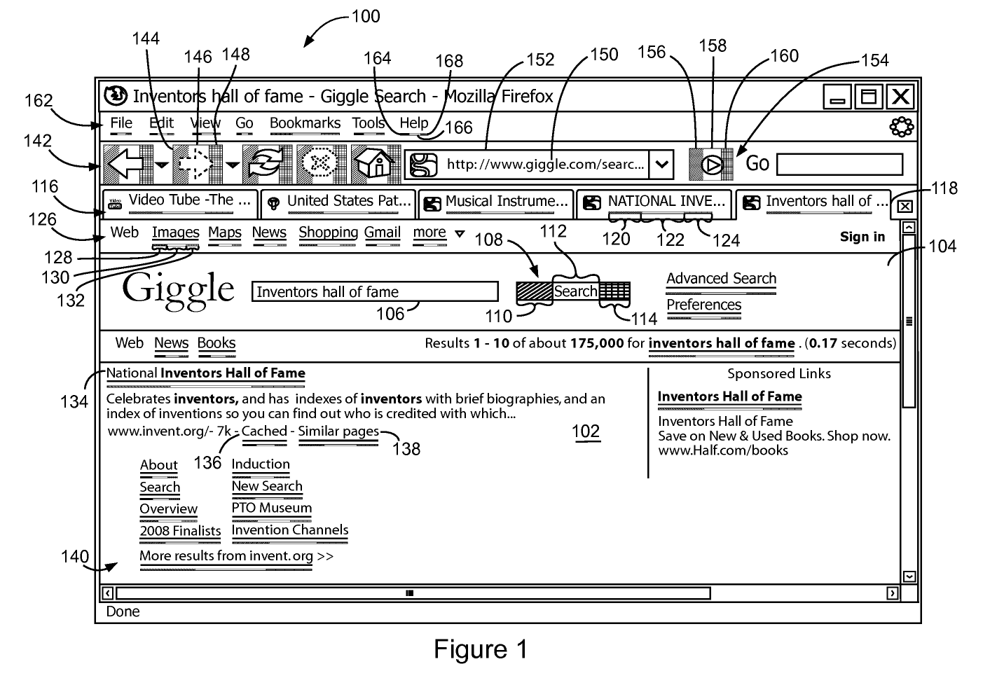

FIG. 1 is a screen image of a web browser window 100 that includes content of a search result 102 in a window 104. A user (not shown) can enter a different query at 106 and click search button 108 to obtain different search results in response to the query. In one embodiment, search button 108 has a control surface, or “button” area, that is configured into three different portions 110, 112, and 114. The user can click on a portion to simultaneously trigger the search and provide an indication of the user's state of mind. A click on the left portion 110 initiates the next search and indicates user disapproval of the current search results 102. A click on the right portion 114 initiates the next search and indicates user approval of the current search results 102. A click on the middle portion 112 operates only the search 102 and the user's state of mind (in this case “approval,” or “disapproval”) is not indicated. Referring to FIG. 1, the web browser window 100 includes a plurality of tabs 116. The user navigating from a current tab 118 has an opportunity to output the state of mind about the current search result 102 as each of a plurality of tabs 116 is configured into at least three different areas 120, 122, and 124.

The hyperlinks 126 on the top left corner of the web browser window 100, for example Images, Maps, News and the like, can also each be configured into at least three areas 128, 130 and 132 underneath thereof to permit indication of the user's state of mind. Hyperlinks in the body of the search result 102 (for example, main link 134, cached 136, similar pages 138 and a plurality of links 140 under the main link 134) can also be adapted to facilitate indication of the user's state of mind simultaneously with the operation or activation of the hyperlinks 134, 136, 138 and 140 in the web browser window 100. A click on at least one of control button 142 on top of the web browser window 100 (for example reload button, home button, back button, forward button and the like can be configured into a plurality of areas as shown for the forward button that has portions 144, 146 and 148 for indicating the user's state of mind on the currently displayed content 102. As another example of a control that can be adapted for indicating a user's state of mind, “go button” 154 is used to navigate to a new web page and can also be provided with one of three configured areas 156, 158 and 160, associated with, respectively, user disapproval, no state of mind indication, and user approval.

Other web browser, window or web page controls can be adapted for indicating a user's state-of-mind. For example, a menu list (not shown) on the locator bar 152 can show a history of previously visited web pages. Each entry in the menu list can be provided with three (or, as later explained, two or more) portions for selecting the entry and also indicating a user's state of mind. When an entry is moused over, the user's state of mind is indicated underneath each URL (not shown) in the history and a click on at least one portion of the entry can indicate the user's state of mind. Drop down menus 162 such as file, edit, view, go, bookmarks and the like which are at the top of the web browser window 100 that leads away from the current window 104 can have indications such as 164, 166 and 168 to identify the user's state of mind. Each of the plurality of hyperlinks 134 on the web browser window 100 may have provisions to get an indication from the user about the state of mind regarding the current page 102.

In general, whenever a user is navigating away from content, or affecting the display of content, or even performing a function not related to the content, the control that is activated by the user can be adapted with one or more features described herein to also indicate the user's state of mind.

The controls in a GUI can be operated with an apparatus that comprises a processor and a processor-readable storage device. The processor-readable storage device has one or more instructions that display the control, define a plurality of portions or areas in the control, accepts signal from a user input device for simultaneous, concurrent (i.e., close in time) or associated operation of the control and selection of at least one of the areas of the control, and indicates the user's state of mind corresponding to the selected area.

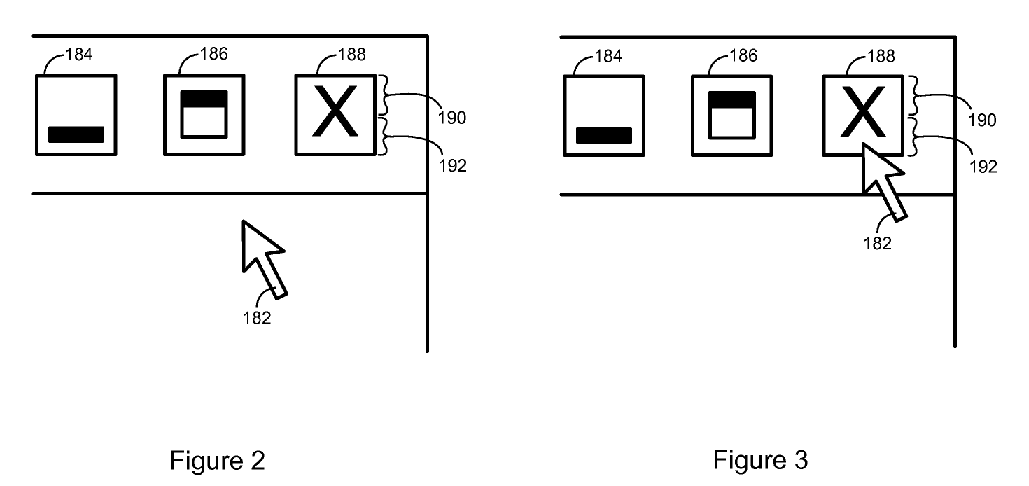

FIG. 2 shows a blown-up view of the window control buttons 180 in the upper-right corner of the web browser window 100 with a pointer 182. The pointer 182 is placed away from the window control buttons 184, 186 and 188. The window control buttons 184, 186 and 188 on the web browser window include the minimize button 184, the maximize button 186 and the close button 188. These buttons 184, 186 and 188 allow the user to minimize, maximize and close the web browser window 100 respectively with the pointer 182 on the display screen (not shown). These standard functions are well-known in the art.

FIG. 3 shows a blown-up view of window control buttons 184, 186 and 188 in an upper right corner of the web browser window 100 with the pointer 182 over the close button 188. In FIG. 3, operating one of the buttons, such as the close button 188 can indicate the user's state of mind while also performing the button's standard function. The close button 188 has a first area 190 as an upper portion and a second area 192 as a lower portion. In one embodiment of the invention, clicking on the first, upper, area 190 of the close button 188 closes the web browser window 100 and indicates the user's approval about the current content displayed in the window. Similarly, clicking the second, lower, area 192 of the close button 188 shows the user's disapproval and closes the web browser window 100.

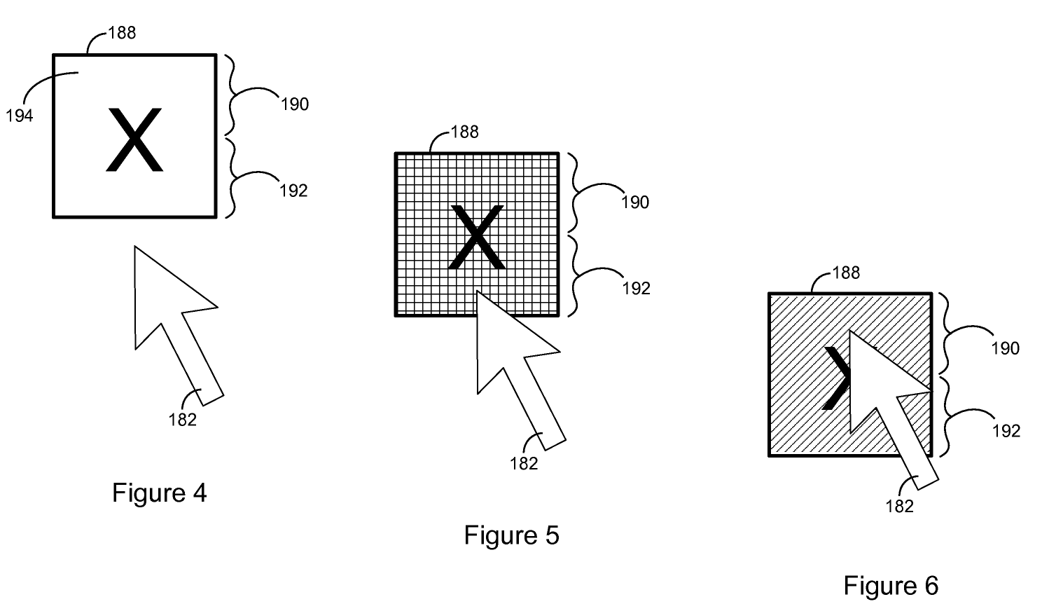

FIG. 4 shows a close-up view of the close button 188 and the pointer 182. The inner area 194 of the close button 188 is configured into the first area 190 and the second area 192, each serving as an active region when the pointer 182 is placed on the close button 188. The color of the close button 188 changes, when the pointer 182 is over at least one of the active regions 190 and 192 of the close button 188. It should be apparent that other graphical characteristics of the areas can be used such as changing a pattern, brightness, hue, saturation, animation, etc. In general, any display characteristic, or texture, of a control can be used.

With reference to FIG. 5, when the pointer 182 is over the second area 192 of the close button 188, the color of the close button 188 changes and the user's disapproval or dislike on the current content 102 can be indicated.

FIG. 6 shows the pointer 182 placed over the first area 190 of the close button 188. In the preferred embodiment, a change in the texture of the close button 188 can be observed and clicking the first area 190 indicates the user's approval or affinity about the current content 102. The first area 190 and second area 192 can be color-coded; for example, the first area 190 can be red and the second area 192 can be green.

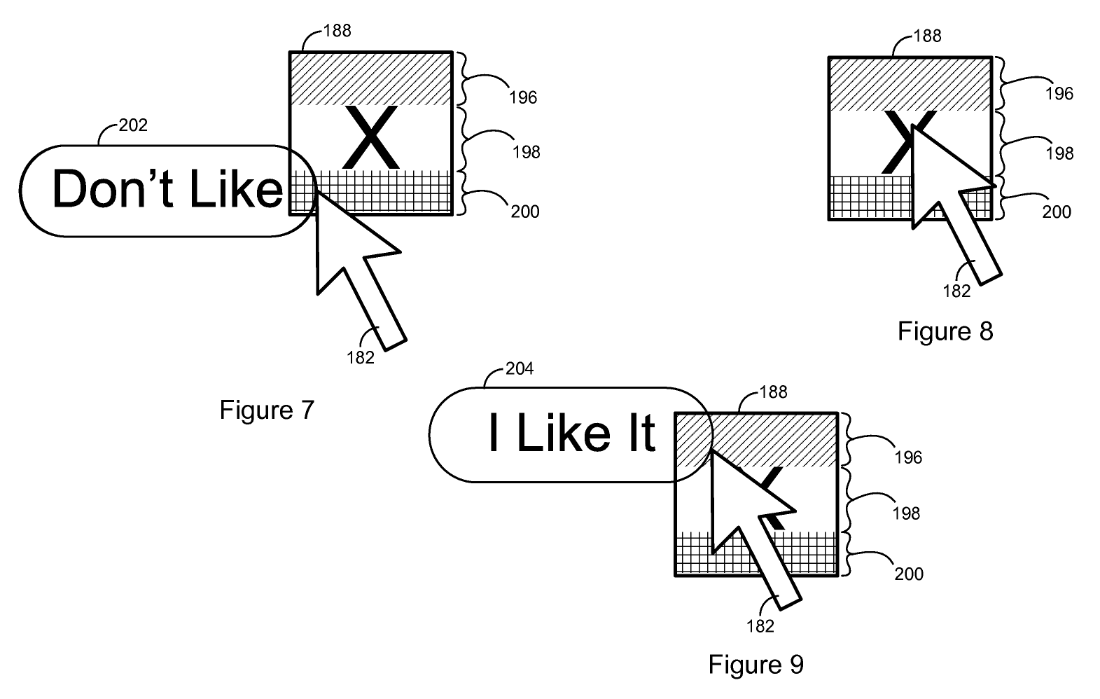

FIG. 7 is an alternate embodiment of the invention illustrating a close button 188 configured into at least three sections such as an upper area 194, a middle area 196 and a lower area 198 where the upper area 194 and lower area 198 have different texture to distinguish them from the middle area 196. As the texture of the upper area 194 and the lower area 198 are permanently coded in this example embodiment, the texture remains even when the pointer 182 is moved away from the close button 188. When the pointer 182 is over the lower area 198 of the close button 188, a text bubble 200 appears to display phrases that describe the selected user mood such as “Don't Like”. The text bubble 200 alerts the user that he is about to indicate his dislike regarding the current content 102. The upper 194 and lower areas 198 can be color-coded; for example, the upper area 194 can be green and the lower area 198 can be red.

FIG. 8 shows the pointer 182 overlaid on top of the middle area 196 of the close button 188, which is the non-indicating area. The middle portion 196 indicates neither approval nor disapproval. Operation of middle area 196 closes the web browser window 100 and it is not associated with the state of mind of the user. At least one of the bubbles 200 and 202 that pops up and alerts the user may contain various text, symbols, signs and marks.

FIG. 9 shows the pointer 182 overlaid on top of the upper area 194 of the close button 188. At least one of the text bubble 202 pops up and says words “I Like It”, when the pointer 182 is over the upper area 194 of the close button 188. A click on the upper area 194 of the close button 188 closes the web browser window 100 and outputs the user's approval or like on the current content 102. The background of the pop up bubbles 200 and 202 can be color-coded or crosshatched. [CJK ENDED EDITING HERE 4-6-09]

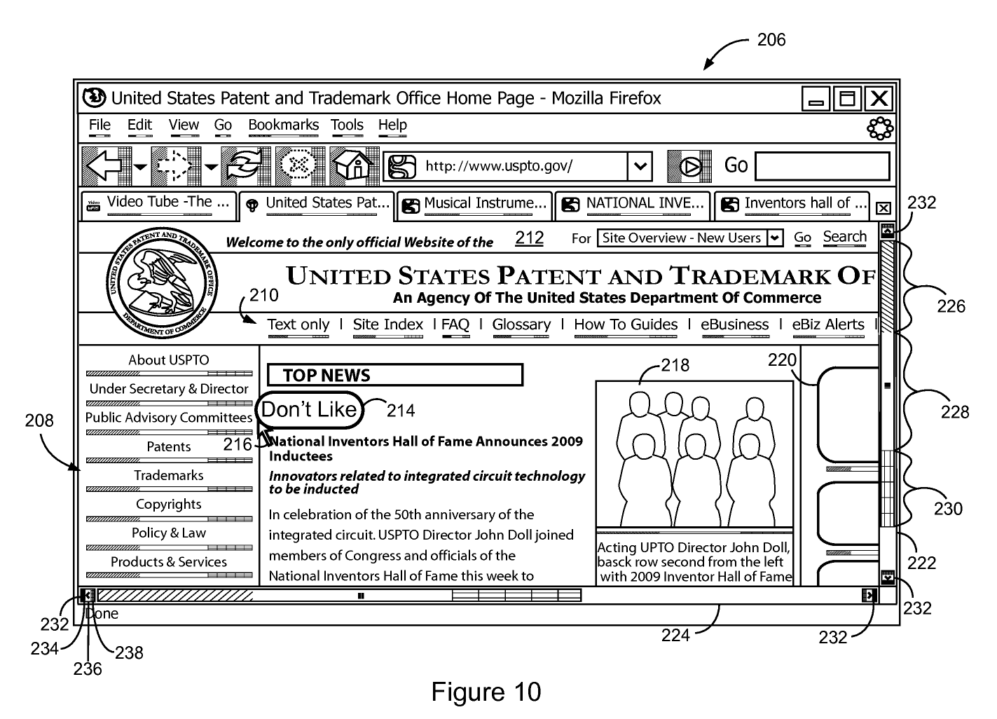

FIG. 10 shows a screen image of a web browser window 204 with a plurality of buttons, hyperlinks, advertisements, pictures, scroll bars and sizing buttons. Each of the plurality of buttons 206 on the left-hand side has state-of-mind indicators. Hyperlinks 208 that do not change the entire web page 210 or a part of the web page 210, for example, Text Only, Site Index, FAQ and the like in the webpage 210, can detect user state of mind. At least one bubble 212 that designates the state of mind of the user pops up when the pointer 214 is over at least one of the buttons 206, links associated with pictures 216 and advertisements 218. At least one or both of the vertical scroll bar 220 and horizontal scroll bar 222 are configured into different areas 224, 226 and 228 that accept the state of mind of the user. The user's state of mind can be determined and sent over the network depending on where the user clicks on at least one of the scroll bars 220 and 222. The plurality of sizing buttons 230 on the web browser 204 is configured into a plurality of areas 232, 234 and 236 that accepts the user's state of mind. The user is alerted about the meaning of clicking on a particular location of the sizing button 230 through the pop-up bubble (not shown).

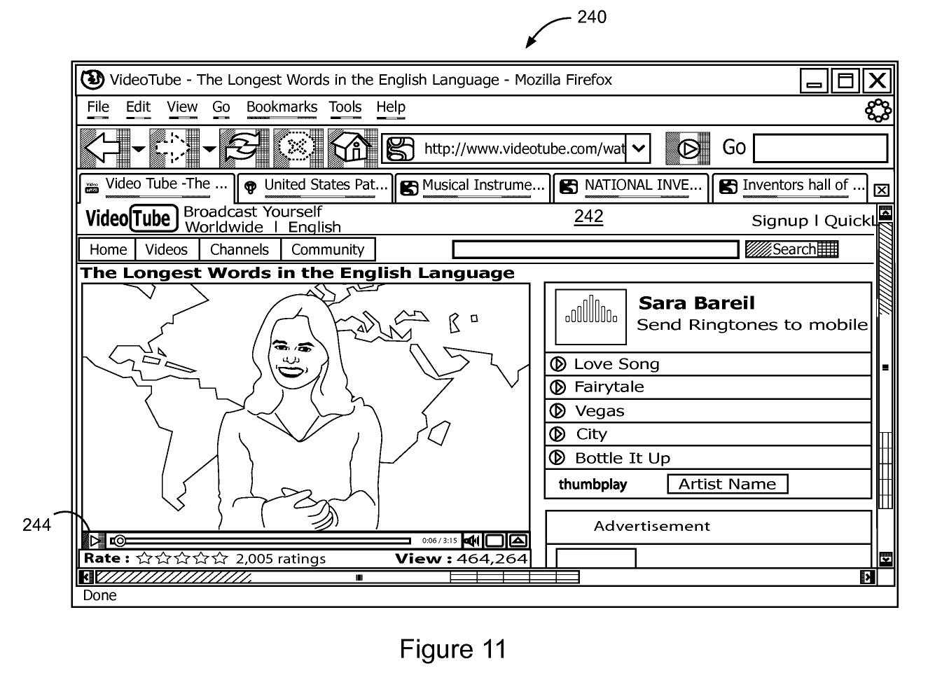

FIG. 11 shows a screen image of a web browser window 238 with at least one video 240. Video transfer controls such as stop, play, pause, rewind, fast forward and the like can have state-of-mind indicators. The user can control the video 240 by clicking at least one of the buttons 242. The button 242 simultaneously operates and accepts the state of mind of the user. The change in texture of the controls in the web browser window 238 illustrated above preferably includes a grid-like cross-hatching, a diagonal hatching, a color change or any other visual indicators.

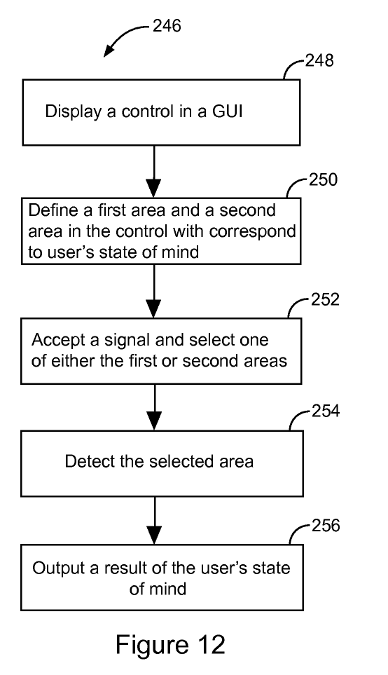

FIG. 12 shows an operational flowchart 246 illustrating the steps for operating a control in a graphical user interface (GUI). The processor-readable storage device displays the control in the GUI as indicated at block 248. At block 250, a first area and a second area in the control are defined that corresponds with a first state of mind of a user and a second state of mind of a user respectively. At block 252, concurrent operation of the control occurs by accepting the signal from a user input device thereby selecting at least one of the areas of the control and detecting the selected area simultaneously as indicated at block 254. At block 256, a result of the user's state of mind corresponding to the selected area is outputted.

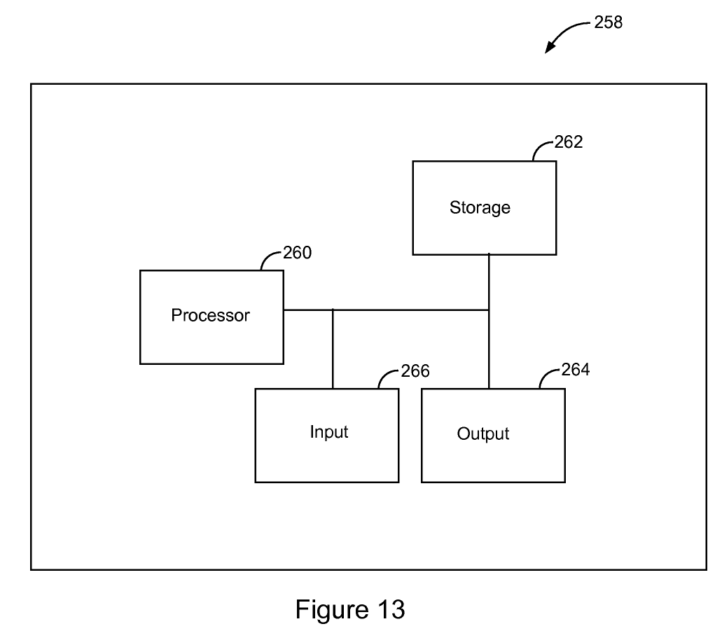

FIG. 13 illustrates a device 1010 that includes various hardware components such as a processor 1020 coupled to storage 1030, user output 1040 and user input 1050. Such an arrangement may be used, for example, in a cell phone, computer system, music player, camera, game console or other processing device. Processor 1020 may include one or more discrete processors, discrete or integrated circuitry, or other hardware components to execute instructions and/or perform functions. Storage 1030 may be solid state memory, magnetic or optical media such as a hard disk drive (CD or DVD disc), etc. User output 1040 is typically a display screen. However, in other embodiments or applications other types of user output components may be used such as an audio speaker (e.g., for voice or audio communication), discrete lights used as indicators, vibration or other motion or tactile feedback mechanisms, etc. User input 1050 can include a keyboard, touch screen; mouse, trackstick or other pointing device; voice recognition, motion detection, etc. It should be apparent that FIG. 13 is merely illustrative of basic components in a device suitable for use with particular embodiments of the invention and that variations are possible.

In FIG. 13, the interconnections among components are simplified and intended to show general communication rather than explicit wired connections. For example, a processor need not be directly coupled to user input and output components. An alternative design could have the processor communicate with user input or output components via the storage as with direct memory access. Yet another example is for the processor to communicate with input or output components by using a separate set of interconnections that are not also used by the processor-storage communications. In general, any suitable interconnection or communication approach may be employed such as wired, wireless (radio-frequency, infrared, etc.), optical, acoustic, etc. means of communication.

The basic hardware design of FIG. 13 can be easily adapted to more specific hardware. For example, microprocessors designed and/or manufactured by companies such as Intel, Motorola, Advanced Micro Devices (AMD), International Business Machines (IBM), Tilera, etc., may be used. Microprocessors types such as Pentium™, Athlon™, or other lines or models may be used. General-purpose computers such as Personal Computers (PCs) may be employed. For example, a Dell Dimension™ 2400 desktop computer with associated peripherals such as a display, mouse and keyboard may be used.

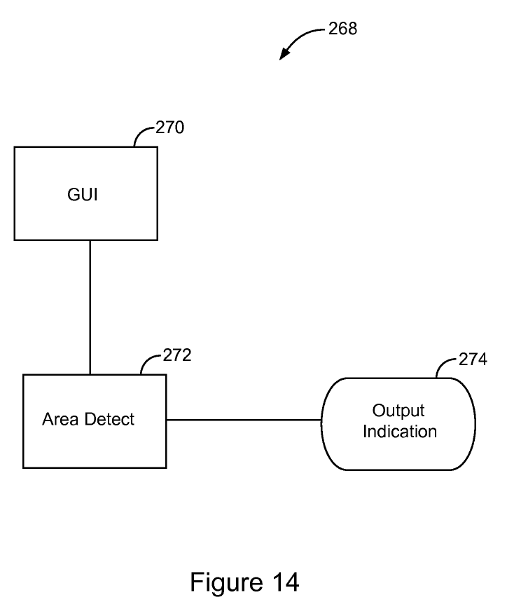

FIG. 14 illustrates a possible software arrangement or design suitable for implementing particular embodiments or functionality as described herein. In FIG. 14, GUI module 1110 determines when a GUI control has been activated or accessed by a user. Such functionality is typically provided by an operating system via predefined routines or interfaces such as a “toolkit,” Application Programming Interface (API), etc. However, customized code can be written to detect GUI control operation, or to work with various operating system routines in order to determine GUI control operation. Many variations of software design are possible and often with today's processing speeds and capacities it is not critical to optimize or provide any specific type of design so that many types of designs, even inefficient or unusual designs, can be used effectively to implement functionality described herein. For example, the GUI module 1110 may be implemented by other than the operating system.

Area detection 1120 receives signals (e.g., variables, values or other data) from GUI control module 1110 and determines whether the user has selected a predefined area in a GUI control. If so, an indication 1030 of the corresponding are is output. The output signal or data value can be used in many useful applications such as in marketing, advertising, consumer research, education, social behavior analysis, government, etc. In general, any field or application where it is useful to understand a user's intention, mood, belief, or other characteristic may benefit from receiving indication 1030. For example, if a user expresses dislike for an item or other information displayed on user output 1040 then that item or information may be prevented from further display to that user or to other users to improve user satisfaction of a website, software tool, merchandise, class course, etc.

Although the description has been described with respect to particular embodiments thereof, these particular embodiments are merely illustrative and not restrictive.

Any suitable programming language can be used to implement the routines of particular embodiments including C, C++, Java, assembly language, etc. Different programming techniques can be employed such as procedural or object-oriented. The routines can execute on a single processing device or multiple processors. Although the steps, operations, or computations may be presented in a specific order, this order may be changed in different particular embodiments. In some particular embodiments, multiple steps shown as sequential in this specification can be performed at the same time.

Particular embodiments may be implemented in a computer-readable storage medium for use by or in connection with the instruction execution system, apparatus, system or device. Particular embodiments can be implemented in the form of control logic in software or hardware or a combination of both. The control logic, when executed by one or more processors, may be operable to perform that which is described in particular embodiments.

Particular embodiments may be implemented by using a programmed general-purpose digital computer, by using application specific integrated circuits, programmable logic devices, field programmable gate arrays, optical, chemical, biological, quantum or nanoengineered systems, components and mechanisms may be used. In general, the functions of particular embodiments can be achieved by any means as is known in the art. Distributed, networked systems, components, and/or circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope to implement a program or code that can be stored in a machine-readable medium to permit a computer to perform any of the methods described above.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

Thus, while particular embodiments have been described herein, latitudes of modification, various changes and substitutions are intended in the foregoing disclosures, and it will be appreciated that in some instances some features of particular embodiments will be employed without a corresponding use of other features without departing from the scope and spirit as set forth. Therefore, many modifications may be made to adapt a particular situation or material to the essential scope and spirit.

1. A method for operating a control in a graphical user interface (GUI), the method comprising:
displaying a control in the GUI, wherein the control has a primary function;
defining first and second areas in the control, wherein the first area corresponds with a first state of mind of a user and wherein the second area corresponds with a second state of mind of the user;
accepting a signal from the user input device to operate the control and select one of either the first or second areas;
detecting the selected area; and
outputting an indication of the user's state of mind corresponding to the selected area.

2. The method of claim 1, wherein the signal simultaneously indicates the user's state of mind and initiates performance of the primary function.

3. The method of claim 1, wherein the control includes a navigation control.

4. The method of claim 1, wherein the control includes a video transport control.

5. The method of claim 1, wherein the control includes a web browser control.

6. The method of claim 1, wherein the control includes a hyperlink.

7. The method of claim 1, wherein the control includes a window close button.

8. The method of claim 1, wherein the control is included in a computer operating system.

9. The method of claim 1, wherein the control comprises a button accessed by a pointer on the display, wherein the user input device includes a pointing device used to move the pointer and select the button, the method further comprising:
defining the first area as an upper portion of the button; and
defining the second area as a lower portion of the button.

10. The method of claim 9, wherein the first area corresponds with user approval and wherein the second area corresponds with user disapproval.

11. The method of claim 1, further comprising:
displaying a pointer on a display screen, wherein the GUI is also displayed on the display screen;
determining when the pointer is over the control; and
displaying an indication of the state of mind associated with an area of the control underlying the pointer.

12. The method of claim 11, further comprising:
displaying an indication of approval when the pointer overlays at least a portion of the first area; and
displaying an indication of disapproval when the pointer overlays at least a portion of the second area.

13. The method of claim 1, wherein the first and second areas are color-coded.

14. The method of claim 13, wherein the first area includes red and the second area includes green.

15. A method for operating a control in a graphical user interface (GUI), the method comprising:
displaying a control in the GUI;
accepting a signal from a user input device to operate the GUI control;
providing an indication of one of at least two different states in association with operation of the GUI control; and
determining that a user is operating the GUI control concurrently with selection of the indicated state.

16. The method of claim 15, wherein the state includes a state of mind of the user.

17. The method of claim 15, wherein the state includes a characteristic of the user.

18. The method of claim 17, wherein the state includes a political affiliation of the user.

19. An apparatus for operating a control in a graphical user interface (GUI), the apparatus comprising:
a processor;
a processor-readable storage device including one or more instructions for:
displaying a control in the GUI;
defining first and second areas in the control, wherein the first area corresponds with a first state of mind of the user and wherein the second area corresponds with a second state of mind of the user;
accepting a signal from a user input device to simultaneously operate the control and select one of either the first or second areas;
detecting the simultaneously selected area; and
outputting a result of the user's state of mind corresponding to the selected area.

20. A processor-readable storage device including instructions executable by a processor for operating a control in a graphical user interface (GUI), the processor-readable storage device comprising one or more instructions for:
displaying a control in the GUI;
defining first and second areas in the control, wherein the first area corresponds with a first state of mind of the user and wherein the second area corresponds with a second state of mind of the user;
accepting a signal from a user input device to simultaneously operate the control and select one of either the first or second areas;
detecting the simultaneously selected area; and
outputting a result of the user's state of mind corresponding to the selected area.
